(19) United States
(12) Patent Application Publication
(10) Pub. No.: US 2013/0282494 A1
(43) Pub. Date: Oct. 24, 2013

(54) Process and system for active communication using social media

(71) Applicants: Christopher Peter Newlands, Erskine (GB); Mark John Boyle, Erskine (GB)

(72) Inventors: Christopher Peter Newlands, Erskine (GB); Mark John Boyle, Erskine (GB)

(73) Assignee: Talk Holiday Limited, Glasgow (GB)

(21) Appl. No.: 13/694,651

(22) Filed: Dec. 21, 2012

(30) Foreign Application Priority Data
Apr. 23, 2012 (GB) GB 1 207 120.5

(51) Int. Cl. H04L 29/08

(52) U.S. Cl. CPC H04L 67/22; G06Q 30/0269
USPC 705/14.66; 709/204

(57) ABSTRACT

A computer based process that is adapted to work with a social media visual interface to provide active and real-time communication between users. The social media membership is made up of a plurality of members and the process collects and compares personal information pertaining to each member to identify common characteristics between members. The process also collects and compares information pertaining to one or more travel destinations and/or information relating to activities at a travel destination as provided by each member. The process subsequently uses the information provided by each member to associate each member with another member or with a group of members where each associated member has provided similar characteristics and interests.

### FIELD OF INVENTION

The field of invention relates to social networking.

### BACKGROUND TO THE INVENTION

A social networking service is an online service, platform, or site that facilitates building social networks or social relations amongst people who may have real-life connections or who share common interests, activities, backgrounds. The social networking service typically comprises a representation of each user and social links. Social network services that are web-based typically provide means for users to interact over the Internet, for example via email or instant messaging. Social networking services are generally understood to comprise an individual-centred service where users can share ideas, activities, events, and interests within their individual networks.

Social networking sites can play a vital role in forming relationships and friendships online, for example via on-line dating sites. Therefore, the social networking service provides a platform or facilitates meeting others via an initial stage virtual communication. This arrangement suits many people nowadays where many have very busy working schedules and therefore the social networking service allows communication to take place in a relatively fast, reliable and time efficient manner.

Nowadays, social networking sites and the web allow, for example reviews for purchase, reviews of hotels, reviews of retail goods and reviews of airlines

Tripadvisor® provides a forum where customers can exchange experiences relating to destination and accommodation etc. However, Tripadvisor® and many existing social networking sites have in common that they look to the past or the present and not to the future.

### BRIEF SUMMARY OF THE INVENTION

The present invention relates to information processing using a social network platform, wherein the social network platform is adapted to provide communication channels, in particular relating to travel related matter, for example destination, accommodation etc. such that friends and strangers alike can communicate on a common topic that is mutually interesting to all parties.

In an embodiment the technology disclosed herein is an information platform and process that allows users to actively engage with others with future plans, for example, planning to travel to the same or similar destination.

In an embodiment the technology disclosed herein is an information platform and process that is active in pairing or grouping persons wishing to travel to a common destination or having common interests relating to a destination.

In an embodiment the technology disclosed herein is an information platform and process that allows users with travel needs to efficiently collect, review and exchange information related to their travel plans.

In an embodiment the technology disclosed herein is an information platform and process where the users can actively engage by communicating directly in real time in relation to their travel plans.

Embodiments of the present invention provide a web based system and process for active communication between users, active information retrieval and active information sharing relating to travel or a particular destination.

Embodiments of the present invention relate to social networking, which provides an online community via a social media platform.

One aspect of the present invention provides a computer based process adapted to work with a social media platform providing active and real-time communication between two or more members, wherein the process comprises the steps of:

collecting and comparing information pertaining to each member;

collecting and comparing information pertaining to one or more travel destinations and/or information relating to activities at a travel destination as provided by each member; and

utilising the information provided by each member to associate each member with another member or to a group of members having similar characteristics and interests.

Since the members have related characteristics and interests the social media platform provided by the present invention encourages active and real-time communication between existing friends and strangers (future friends) alike.

The computer based process according to the present invention is directed particularly to travel related subject matter. The process provides an operating background to a social media platform that enables real and active communication between members/users as individuals or groups having in common a desired travel destination or interests associated with a destination. Active communication means real answers can be given to real questions in real time.

The step of collecting information pertaining to each member may include registration by each member, wherein each member may input registration details (for example name, age, marital status, location) directly to the platform. Alternatively, such registration information may be provided indirectly, wherein the process retrieves information via one or more links to one or more other social media platforms or blogs.

This step may represent registration on the social media platform associated with the process.

Following registration, the process may include a further step, wherein registration details may be confirmed and registration may be validated prior to the step of collecting and comparing information relating to one or more travel destinations etc.

Travel related information may include details of a continent, country, city or town of interest. In addition, travel related information may relate to interests, for example adventure holidays, relaxation, sightseeing etc.

The process and the social media platform provided by the present invention may comprise layered structure, wherein each layer is structured to suit a particular status and one layer is visible at any given time. Each layer may be populated with information relating to a travel related matter, for example a first layer may be provided by a platform for discussion before a member travels, a second layer may provide a platform for discussion when a member is at the destination and a third layer may provide a platform for discussion when the member has returned from the destination.

In connection with the above the process of the present invention may monitor and control material visible to the member at any given time. For example visible content on a first layer platform may include details of airport parking, airport transfers, insurance services, currency exchange etc.

It will be appreciated that communication between members can occur within and across each layer, for example a member about to travel (layer one) can communicate with a member currently in the location (layer two).

The process and the social media platform according to the present invention provides a unique interactive travel related experience that is not provided by any other social media site. As such each member may have an enhanced holiday experience. Moreover, safety of at least one member may also be enhanced because the process and platform provides introductions and therefore opportunities for members to meet with others who have interests and travel destination in common. This feature of the present invention may be particularly relevant to solo travellers.

The social media platform controlled by the process according to the present invention is aimed at a membership whose common interest is travelling, holidays/vacations and related activities. A main focus of the social media platform is on the experience before travelling such that the information provided may enhance the travel experience in respect of any forthcoming trip and may also provide a sense of anticipation for future trips, through interaction of members together with tailored advertising.

The process may further comprise collecting and filtering advertising media and controlling population of areas visible to the member to ensure that visible material is relevant to the target group. Filtering the advertising media may take account of age, gender, status etc. of the member. As described above filtering of relevant material may also take account of the status of travel, for example if the travel date is far in the future or the member is on holiday or the member has returned.

The process and social media platform of the present invention may provide an emergency contact facility. Via the social media platform the emergency contact facility may be operable to send a message, for example a text or an email to a nominated person in the event of an emergency. The emergency contact facility may operate or may be activated substantially automatically during the vacation period in times of emergency. To activate the emergency contact facility the member may use an application on a touch device.

Alternatively, or in addition the member may send a dedicated number or code using a device other than touch device. In the event that a mobile portable device has been lost or stolen, activation of the facility may be done from other means, for example by telephone, for example from a call box and contacting a dedicated number or by email from, for example an internet cafe.

Accordingly, the process may further comprise the steps of gathering, processing and initiating an emergency contact facility. In respect of the emergency contact facility the information gathered can be stored and may include personal details pertaining to the member and may include, for example name, age, passport number, next of kin and the name of a nominated person as an emergency contact.

The process may further comprise creating a message that can be sent in the event of activation of the emergency contact facility. The process may create the message automatically from the information provided by the member. Alternatively, the member may be assisted in creating their own message. During or following the registration procedure the process may generate a prompt that allows each member to preview their personal message. The member may be required to approve the message such that in the event the of an emergency and the member needs to use the emergency contact facility they have advance knowledge of the message to be sent. In the event of an emergency a message can be sent in an instant. Advantageously, the prior approval of the message by the member substantially avoids delay in sending effectively a cry for help or an SOS message.

The process may further include collecting information relevant to travel relevant material and retailers, for example tourist information, package holiday companies, flights, car hire, parking etc.

The process may further include managing and filtering such information such that only relevant information is visible to each member via the associated social media platform. As such the process includes tailored advertising such that each member is exposed only to advertising that would be considered of interest to them based on the information provided during the registration and validation steps of the process as described above.

A social media web based site provides a foreground for the process defined above.

Membership of the social media web based site may be arranged by the background process into groups by common characteristics. The site may provide opportunities for such groups to meet virtually, and optionally in person.

### BRIEF DESCRIPTION OF THE DRAWINGS

FIG. 1 is a schematic representation of a communication network associated with a social media platform according to an embodiment of the present invention;

FIG. 2 is a schematic representation of information relating to the process and social media platform according to an embodiment of the present invention; and

FIG. 3 is a schematic representation of the benefits provided by a process and social media platform according to embodiments of the present invention.

### DETAILED DESCRIPTION OF EMBODIMENTS OF THE INVENTION

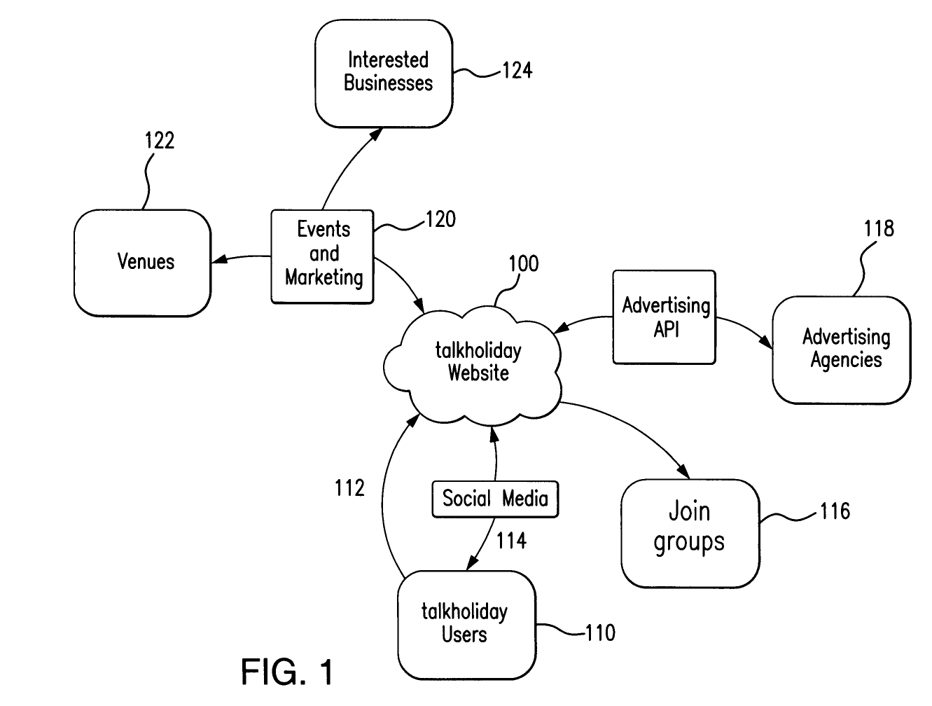

FIG. 1 shows a high-level view of the social media site 100 according to an embodiment of the present invention and indicates the interaction of the platform 100 with external parties. The social media site 100 is referred to as talkholiday™. Talkholiday™ is the trademark used as an indication of the services provided by the social media site 100.

The main communication line is between the social media site 100 and the user 110. The user 110 represents a population of persons interested in the main discussion topics of the social media site, in this case travel related matters. FIG. 1 indicates that the user can access and register to the 100 site directly 112 or via another social media site 114, for example facebook®.

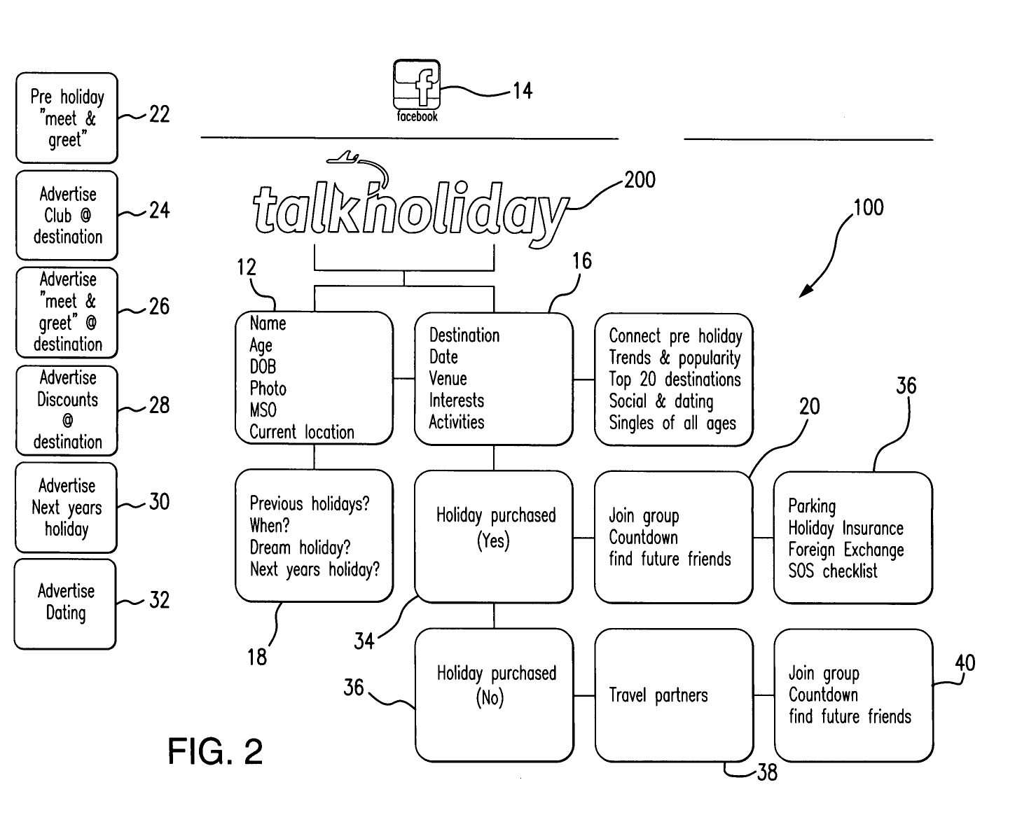

Once registered with the social media site 100 the user becomes a member and is then given the opportunity to join a group 116. Group membership will be controlled by the background process according to an embodiment of the present invention and is described further below with reference to FIG. 2.

FIG. 1 also illustrates interaction with the site 100 by interested businesses and agencies 118, 124 that wish to target and market their merchandise to the membership.

An example of interested businesses 124 may be product/service providers in the tourism industry or associated advertising agencies 118. Such businesses may be general tour industry providers, for example package holiday companies, airlines, vehicle hire providers etc. Alternatively or in addition businesses located within a specific destination may have interest in promoting their products, for example restaurants, tour guides etc. to the member in advance of their arrival at the destination.

A beneficial element of the social media site 100 is that the members 110 are encouraged to meet. As with other social media sites members 110 can meet virtually. However, an added feature of the site 100 according to the present invention is that members 110 are encouraged, for example by tailored advertisements, to meet in person. Therefore, events and marketing 120 is included in FIG. 1 as a communication line directly from the site 100.

It will be appreciated that events, where the members meet in person, require venues to host such events. Suitable venues 122 can register and subscribe to the site 100 such that their services can be promoted as a suitable meet and greet venue to encourage sociability amongst the members can meet in person subsequent to first meeting virtually by joining a group 116 via the social media site 100.

The background process, described further with reference to FIG. 2, collects and monitors information provided by members and external parties such as vendors as such the relevance of any venue to a particular member group is identified and the process associates it with and allows display of information relating to the venue on the visual interface seen by the members.

FIG. 2 illustrates a representation of data provided to and from the social media site 100 described above with reference to FIG. 1. Data is input to the site and is collected and processed by the background process according to the present invention.

Beneficially, the embodiments described represent a new way of using social media.

FIG. 2 is a schematic representation of the social media site 100 referred to in FIG. 1. The social media platform in FIG. 2 is named talkholiday™ 200. The purpose of the social media site 100 is to provide a single web-based destination for anyone considering travelling for social or business purposes or anyone planning a trip or researching a particular destination.

A full feature version of the social media site 100 will be accessible to members only. As such it will be appreciated that members need to join via a registration process. Registration 12, 16 may be a two stage process, where in the first stage 12 personal information pertaining to the member is provided and in the second stage 16, following registration, travel specific information is provided.

The first stage 12 of the registration process requires information such as name, age, date of birth, a photograph, marital status and current location to be input to the site 100 for processing and approval. Such information can be provided by direct entry to the site 100 or indirectly by prior registration to a linked site, for example facebook® 14.

Upon approval or verification the user becomes a member and will be prompted to provide further information relating to their travel plans in the second stage 16 of the registration process. By providing such information the user will gain access to the full feature version of the social media site 100 that is talkholiday™.

In the second stage 16 of the registration process the member can provide information relating to the destination of travel, nature of travel, for example social or business, date of travel, details of places of interest, details of activities of interest etc. In addition, the member can enter information relating to previous travel experiences 18, providing details of where and when they travelled. Also, the member can provide and share information relating to their dream holiday destination and any planned holidays 18.

From the information provided the background process according to embodiments of the present invention collects the information provided and compares it with information supplied by other members. The process then provides the member with details of one or more groups 20 within the social media community. Each group 20 comprises members with things in common, for example members travelling to the same destination or members having similar characteristics (for example age, marital status etc.) or similar interests (for example, walking, good wines, sightseeing etc.).

It will be appreciated that the information provided by each member is used by the background process to ensure that each member is associated with a relevant group.

By creating groups, an objective of the social media site 100 illustrated as talkholiday™ 200 is met because members are encouraged to actively engage and discuss their travel plans and travel needs and to actively discuss their interests and any concerns they may have. The interaction by users is virtual in the first instance, but by suitable advertising and promotions via the user interface the social media site 100 encourages members to meet in person.

Advertising and promotional material relating to travel related matters will be available via the site 100. However, the background process will use information about members to ensure that any advertisements and promotional material is tailored to the individual or the group 20. As such the visual interface will generally display information that is relevant to each member.

Advertisements and links to other sites may be provided on the social media site, for example links to venues to arrange or register for meet and greet events 22 may be provided. Interested sponsors may have a venue in, for example, a city centre location accessible to a group of members and as such each member will have the opportunity at least to meet someone in advance of travelling to their chosen destination with the potential of establishing future friendships. One incentive of the social media site 100 and the process according to the present invention controlling is to encourage friendships to be made as such a beneficial feature of the social media platform 100 according to the present invention is the ability to join groups and to “find future friends™” 23.

FIG. 2 illustrates how advertisements on the social media site 100 can be tailored to each member. In the example illustrated FIG. 2 shows advertisements relating to a pre-holiday greet and meet event 22, advertisements relating to a club located at a destination 24, advertisement for a meet and greet event at a destination 26 and advertisements for discounts at the destination 28.

In addition, FIG. 2 shows advertisements relating to future plans such as information about a future travel plans and associated travel deals 30. FIG. 2 also shows an advertisement relating to dating 32.

Such advertisements may provide a link to a sponsored site.

Background processing of the information provided by a member during registration or when updating registration to the social media site 100 ensures that the site 100 only displays links and advertisements that are considered relevant and of interest to each member.

FIG. 2 also illustrates a stage in the process represented by box 34 and box 36, each relating to a different status of the member's holiday/travel plans. Box 34 represents a positive decision where a holiday is formally booked or purchased and box 36 represents the situation where a holiday is being planned and is not yet booked or purchased. This information is processed and should affect the visual content of the site 100 because if the member has purchased a holiday their outlook likely differs from that of a member who is in the early stages of planning a trip.

Purchase means commitment and therefore finding members with common interests and travelling to the same destination and a holiday countdown 36 would likely warrant early consideration by the member group. Later consideration, as the time for departure approaches, most likely turns to actual travel related matters such as indicated in box 36, for example airport parking provisions, travel insurance, exchange rates and an SOS checklist as described further below as a beneficial feature of the present invention.

In the situation where the member is planning a trip, early consideration would most likely be given to where the member wishes to travel and where personal interests may play a part in the decision. Often budgetary constraints influence the choice of destination. As such the social media site 100 provides information from travel partners 38. Travel partners may be for example travel advisors or retailers selling holiday packages. In the planning stages such a link to a travel partner 38 (travel or holiday company) may provide the member with tailored information to make the selection process easier. When the member finally commits to a travel destination or travel date their consideration can turn from planning to communication with others (box 40 FIG. 2) by joining a relevant group within the social media community, counting down the months, weeks and days until they travel and to making new friends (find future friends™) 40.

Included in FIG. 2, as referenced above with respect to box 36, is a beneficial element of the social media site 100, which is the provision of an SOS feature 36. The SOS feature 36 provides an emergency contact facility, which via the social media site 100, may be operable to send a message. The message may be provided by, for example a text or an email to a nominated person in the event of an emergency.

The emergency contact facility may operate or may be activated substantially automatically during the vacation/travel period in times of emergency. For example, to activate the emergency contact facility the member may use an application on a touch device to send a message to a nominated person. Other means of activation may be considered such as using a dedicated number or code if activated by telephone or email.

The SOS feature included in box 36 is a feature of the background process according to an embodiment of the invention where the information provided by the member is gathered and used to create and store a message that can be sent in the event of activation of the SOS feature 36.

The information used to create a message may include for example, name, age, passport number, next of kin and the name of a nominated person as an emergency contact. It is expected that during or following the registration procedure each member will be offered a preview of their personal SOS message and may be required to approve the message such that in the event the member needs to use the SOS feature 36 they have advance knowledge of the message that will be sent. This is a beneficial element of the SOS feature 36 because in the event of an emergency instant action may be required and as such the prior approval of the message by the member can avoid any delay in sending a cry for help. Emergency situations do arise and as such the SOS feature 36 is beneficial.

A social media site 100 controlled by the process of the present invention beneficially provides a truly interactive social media experience where members can communicate in real time, post real questions, post real reviews and post real answers such that information input and displayed is continuously updated and is current.

In the conceptual stages of the social media site 100 that can be recognised by the trademark talkholiday™, the primary focus was on a membership of twenty to thirty-nine year olds, young holiday makers and solo travellers (for example gap year students, single, widowed or divorced individuals). However, as the concept has grown it became apparent that the social media site 100 could appeal to a wider audience that may include older, more experienced travellers, and family groups.

The social media site 100 or visual interface provides the foreground of the process according to the present invention and may include links to other social media interfaces, for example facebook® 14. However, the social media site 100 described herein should be able to operate as a standalone platform that does not rely on the interaction with other social media sites. Interaction with other sites may enhance the features of the social media site 100 described herein.

The background process according to the present invention intelligently collects and processes information from registered members forming the membership and interested third parties such as travel companies, car hire companies, tourist information etc. The processor processes and monitors information and matches it with the needs of the membership such that information deemed relevant is displayed to each member.

Communication between members is a beneficial objective of the social media site 100 as illustrated in FIGS. 1 and 2. An incentive of the social media site 100 provided by the present invention is to make social media more sociable because the membership can communicate in real time, they can communicate/meet virtually and they can meet personally. As such future friendships may be secured before members arrive at their destination. Find future friends™ is a trademark to be associated with the social media site 100.

The social media site 100 provided by the present invention focuses on travel related features with an emphasis on pre-travel factors to provide an insight to any destination from others who have recently or even those who are presently experiencing the travel destination. The social media site 100 seeks to enhance the travel experience of its members because it provides each member with the opportunity to interact with others and also to benefit from incentives provided by sponsors of the interactive site.

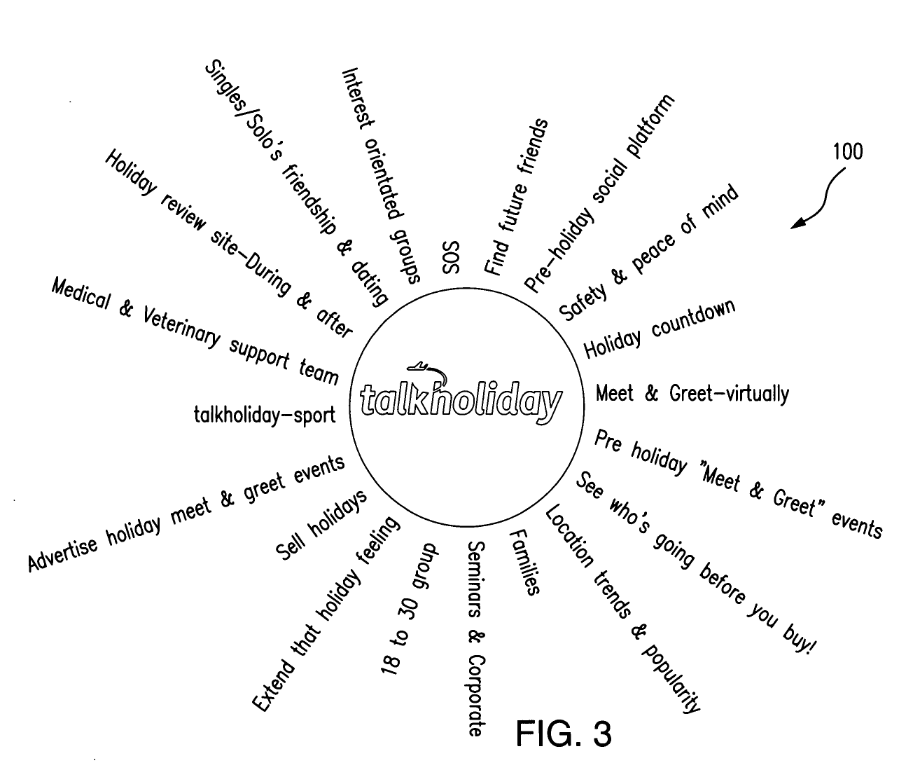

Many of the features and benefits of the social media site 100, represented by the trademark Talkholiday™ is illustrated in FIG. 3 in the form of a sun-like image. FIG. 3 illustrates target groups and details of potential sponsors who can add value to the community.

The social media site 100 encourages members to be sociable by membership of interest orientated groups that are generated from the information provided when a member registers. To encourage sociability friendships can be made (find future friends™). In this regard members are encouraged to meet virtually and in-person before, during and after travelling. By doing so the members can see who is travelling to the same destination. As such most members can make an informed decision with regards their travel plans. By meeting new people with similar travel plans or interests each member may benefit from a feeling of safety and peace of mind because they can address any fears or anxieties by communicating with others.

As the social media community grows more and more information will be collated and as such the site should be able to produce statistics that show trends and popularity that may help a member reach a decision about where to go.

The site 100 would be available to all, but a benefit of using the site is the grouping with other members having similar characteristics. As such the site may appeal equally to young travellers, for example eighteen to thirty year olds, twenty to thirty nine year olds (“twirties”), single persons, solo travellers, families and even persons travelling with animals/pets.

To cater for all members the site may provide information relating to, for example buying and selling holidays, tailored advertising.

Incentives to join the community may be provided by many of the support features provided, for example the SOS feature described above, access to medical and veterinary support directly from the site and access to a holiday countdown facility. In addition, the interactive nature of the site 100 should provide on-going, current reviews of travel related matters. As such each member can make a better informed choice with regards to their travel plans.

Talkholiday™ is concerned with enhancing and extending the travel experience for each member and to make social media more sociable.

Whilst the invention has been described with respect to specific embodiments, it will be appreciated that the invention is intended to cover modifications and equivalents within the scope of the following claims.

1. A computer based process adapted to work with a social media visual interface thereby providing active and real-time communication between two or more members, wherein the process comprises the steps of:
collecting and comparing personal information pertaining to each member;
collecting and comparing information pertaining to one or more travel destinations and/or information relating to activities at a travel destination as provided by each member; and
utilising the information provided by each member to associate each member with another member or to a group of members having similar characteristics and interests.

2. The computer based process of claim 1, wherein the step of collecting personal information pertaining to each member includes registration to the social media platform via a visual interface wherein each member can input registration details such as name, age, marital status directly to the platform.

3. The computer based process of claim 1, wherein the step of collecting personal information pertaining to each member includes registration via a visual interface by retrieving personal information via one or more links to one or more other social media platforms.

4. The computer based process of claim 1, including a further step, wherein personal information is confirmed and validated via a visual interface or databank before the step of collecting and comparing information relating to one or more travel destinations.

5. The computer based process of claim 1, comprising arranging information provided and stored such that the visual interface only displays material relevant to the member or the member group.

6. The computer based process of claim 5, comprising compiling and structuring the information provided into at least three layers, wherein each layer relates to the member's status at any given time, wherein a first layer provides a visual interface relevant to the member or member group before travelling, a second layer provides a visual interface relevant to the member or member group whilst at destination and a third layer provides a visual interface relevant to the member or member group after return from the destination.

7. The computer based process of claim 1, further comprising collecting and filtering advertising media for use with the platform.

8. The computer based process of claim 7, comprising monitoring information relevant to the member and external advertising media such that material visible to the member via the visual interface, when in use is controlled and substantially relevant.

9. The computer based process of claim 1, further comprising generating an emergency contact facility.

10. The computer based process of claim 1, comprising the steps of gathering, processing and initiating, on demand, an emergency contact facility wherein initiating the emergency contact facility is via initiating means.

11. The computer based process of claim 10, wherein initiating means comprise one or more of the following: an application on a touch device, a dedicated number or code, by telephone, by email or by a help button provided on the visual interface.

12. The computer based process of claim 9, comprising storing personal details pertaining to the member including one or more of the following: name, age, passport number, next of kin and name of a nominated person as an emergency contact; and
comprising creating a message to be sent in the event of activation of the emergency contact facility.

13. The computer based process of claim 12, comprising sending the message to a nominated person upon receiving a signal via initiation means.

14. The computer based process of claim 12, comprising automatic creation of the message from stored information provided by the member.

15. The computer based process of claim 12, comprising assisted creation of the message from stored information provided by the member, wherein prompting the user via the visual interface creates the message.

16. The computer based process of claim 1, comprising collecting information pertaining to travel related matter and travel related retailers.

17. The computer based process of claim 16, comprising managing and filtering the information pertaining to travel related matter and travel related retailers such that information relevant to each member is visible to the member via the visual interface.

18. The computer based process of claim 16, comprising tailoring advertising media displayed via the visual interface such that each member is exposed to advertising of interest to them based on the information provided by the member.

19. A social media web based site that is controlled and populated via the process of claim 1.
